(19) United States
(12) Patent Application Publication
(10) Pub. No.: US 2007/0086507 A1
(43) Pub. Date: Apr. 19, 2007

(54) Temperature-indicating eye drop solution container

(75) Inventors: Jae Joong Kim, Seoul (KR); Wan Gi Kim, Gyeonggi-do (KR)

Correspondence Address: BACON & THOMAS, PLLC, 625 SLATERS LANE, FOURTH FLOOR, ALEXANDRIA, VA, 22314, US

(73) Assignee: Hanmi Pharm. Co., Ltd., Kyungki-do (KR)

(21) Appl. No.: 11/431,598

(22) Filed: May 11, 2006

(30) Foreign Application Priority Data
Oct. 14, 2005 (KR) 10-2005-0096817

(51) Int. Cl. G01K 1/08

(52) U.S. Cl. 374/150

(57) ABSTRACT

A temperature-indicating eye drop solution container includes a chamber for containing an eye drop solution, a product label provided on an outer peripheral surface of the chamber and a nozzle part coupled to a top portion of the chamber for dispensing the eye drop solution therethrough. The product label has a temperature indicator formed of a printed thermochromic ink. The temperature indicator adapted to show a distinct color at a proper storage temperature but lose the distinct color at a room temperature.

### FIELD OF THE INVENTION

The present invention relates generally to a temperature-indicating eye drop solution container, and more particularly, to a temperature-indicating eye drop solution container storing an eye drop solution for glaucoma treatment which requires cold storage and having a temperature indicator provided on a product label of the container, the temperature indicator capable of indicating a proper container temperature in a conspicuous color so that a glaucoma patient can use the eye drop solution at a recommended temperature in a daily life.

### BACKGROUND OF THE INVENTION

In general, glaucoma is known as one of the major causes of eyesight loss and has been treated mainly by use of a medical solution administered in the form of an eye drop.

An eye drop solution for treatment of the glaucoma is usually stored in an eye drop solution container. In use, if a patient squeezes the chamber of the container with a small pressure, a droplet of the solution is dispensed from the chamber through a nozzle and falls on an eyeball of the patient.

Such a glaucoma treatment solution shows a difference in its titer and may be degenerated, depending on the storage temperature thereof. This may sometimes cause harmful side effects and reduce the efficiency of treatment. Thus, it is required to store the glaucoma treatment solution at a proper temperature, desirably at a temperature range of 2-8° C.

However, the glaucoma treatment solution commercially available is sold with a product specification that contains a small letter notice of “cold storage required”. For this reason, most of patients are apt to overlook the cautionary notice and have a tendency not to store the glaucoma treatment solution at a cold atmosphere. Even though the patients are instructed by a doctor or a pharmacist to cold-store the solution, the patients forget such instructions over time, leaving the solution as it stands or storing it at an inappropriate temperature. What is worse, the patients are frequently given no instruction regarding the necessity of cold storage from the doctor or the pharmacist.

In view of the foregoing, a need has existed for a means that can assuredly urge glaucoma patients to store and use a glaucoma treatment solution at a recommended cold temperature.

### SUMMARY OF THE INVENTION

It is, therefore, an object of the present invention to provide a temperature-indicating eye drop solution container that has a temperature indicator provided on a product label of the container, the temperature indicator capable of showing a conspicuous color at a proper storage temperature so that a user can visually recognize the color of the temperature indicator and get into the habit of storing the container at a recommended temperature in a daily life.

In accordance with a preferred embodiment of the present invention, there is provided a temperature-indicating eye drop solution container including a chamber for containing an eye drop solution, a product label provided on an outer peripheral surface of the chamber and a nozzle part coupled to a top portion of the chamber for dispensing the eye drop solution therethrough, wherein the product label has a temperature indicator formed of a printed thermochromic ink, the temperature indicator adapted to show a distinct color at a proper storage temperature and lose the distinct color at a room temperature.

### BRIEF DESCRIPTION OF THE DRAWINGS

The above and other objects and features of the present invention will become apparent from the following description of preferred embodiment given in conjunction with the accompanying drawings, in which:

FIG. 1A is a perspective view showing a temperature-indicating eye drop solution container in accordance with the present invention;

FIG. 1B illustrates a temperature indicator showing a thermometer shape with a distinct color in the temperature range of 2-8° C.; and

FIG. 2 is a perspective view illustrating a carton for packaging a temperature-indicating eye drop solution container in accordance with the present invention.

### DETAILED DESCRIPTION OF THE PREFERRED EMBODIMENT

Hereinafter, a preferred embodiment of the present invention will be described in detail with reference to the accompanying drawings.

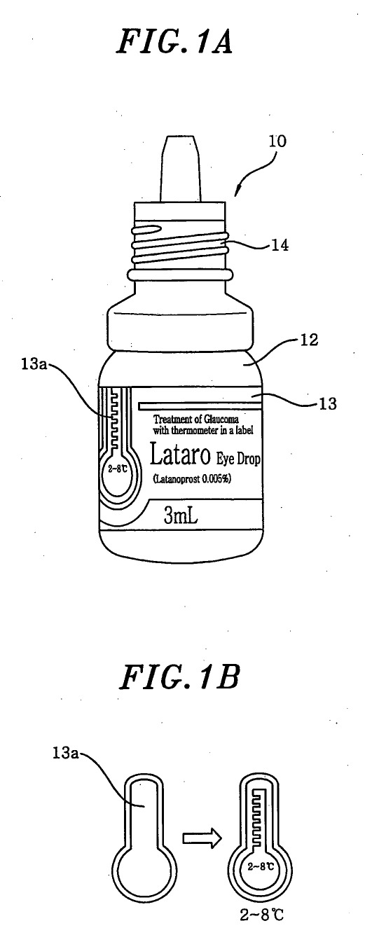

FIG. 1A is a perspective view showing a temperature-indicating eye drop solution container in accordance with the present invention.

A typical eye drop solution container 10 includes a chamber 12 for storing an eye drop solution therein, a nozzle part 14 coupled to the top of the chamber 12 for dispensing the eye drop solution therethrough, and a lid (not shown) removably capped on the nozzle portion 14.

If a user squeezes the chamber 12 with his or her fingers, the eye drop solution stored in the chamber 12 is moved to the nozzle part 14 and then dispensed from the tip end of the nozzle part 14 in the form of a droplet.

On and around the outer peripheral surface of the chamber 12, there is provided a product label 13 on which are printed a trademark, a product specification, directions for use and the like.

According to the present invention, the eye drop solution container 10 includes a temperature indicator 13a provided on a prescribed part of the product label 13. As can be seen in FIG. 1B, the temperature indicator 13a is adapted to show a distinct color at a proper cold storage temperature, e.g., in the temperature range of 2-8° C. but lose the distinct color at a room temperature. The temperature indicator 13a may be embodied by printing a thermochromic ink on the product label 13 in the form of a thermometer or other designs indicative of temperature indicia.

In this regard, the thermochromic ink may be the one that exhibits a specific color (e.g., a blue color or blue-based colors) readily recognizable by the user when the eye drop solution is kept at a proper cold storage temperature. Preferably, the thermochromic ink undergoes color change reversibly in such a manner that the temperature indicator 13a can show the distinct color at the proper cold storage temperature but become colorless at a temperature outside the proper cold storage temperature.

The eye drop solution container 10 may be filled with an eye drop solution for glaucoma treatment. If the container 10 is cold-stored at the proper temperature range of 2-8° C., the temperature indicator 13a of the product label 13 shows a visually conspicuous specific color, thereby allowing the user, i.e., the glaucoma patient, to recognize the storage temperature of the eye drop solution contained in the container 10 without having to measure the temperature thereof. In contrast, if the container 10 is stored at an improper storage temperature, the temperature indicator 13a loses its color thus urging the user to re-store the container 10 at the proper temperature.

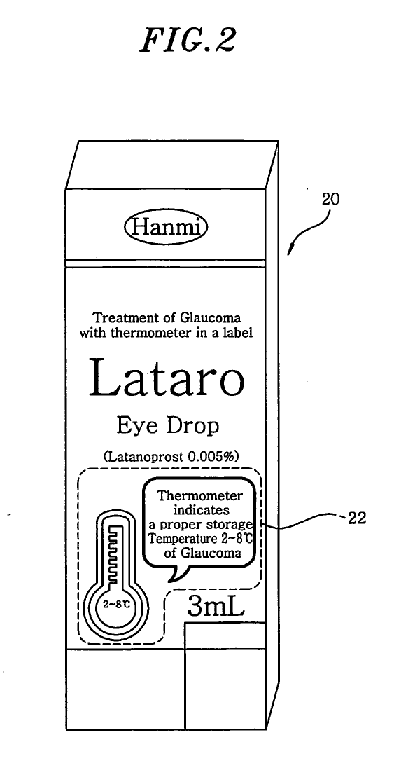

Furthermore, according to the present invention, a carton 20 for packaging the temperature-indicating eye drop solution container 10 carries on its outer surface a directions-for-use 22 informing the user of the provision of the temperature indicator 13a, as illustrated in FIG. 2. The directions-for-use 22 may be in any language (Korean in the illustrated embodiment) and any design. This enables the user to readily recognize the temperature-indicating function provided in the container 10 at the time of purchasing the same, thus assuring that the user can efficiently utilize the temperature-indicating function in storing the eye drop solution container 10.

Thank to these features of the present invention, the user of the eye drop solution container 10 is strongly encouraged to cold-store the eye drop solution at a proper temperature in a daily life, which helps to prevent any reduction in titer of the eye drop solution. This also permits a doctor or a pharmacist to instruct the user on the usage of the eye drop solution in a facilitated manner, eventually maximizing the treatment efficacy of the user's disease, including glaucoma.

Unlike the afore-mentioned embodiment wherein the temperature indicator 13a is formed on the product label 13 with the use of a thermochromic ink, it would be possible that the chamber 12, usually made of a synthetic resin, is provided at its predetermined area with a thermochromic pigment, thus forming the temperature indicator 13a which shows a distinct color at a proper cold storage temperature.

As is apparent from the foregoing, the present invention provides an advantage in that the user gets into the habit of storing the eye drop solution at a recommended temperature in a daily life. Further, the present invention helps to prevent any reduction in titer of the eye drop solution and eliminates the need for a doctor or a pharmacist to instruct the user on the usage of the eye drop solution. In addition, the present invention assists in making the eye drop solution product appeal to the consumer.

While the invention has been shown and described with respect to the preferred embodiment, it will be understood by those skilled in the art that various changes and modifications may be made without departing from the spirit and scope of the invention as defined in the claims.

What is claimed is:

1. A temperature-indicating eye drop solution container including a chamber for containing an eye drop solution, a product label provided on an outer peripheral surface of the chamber and a nozzle part coupled to a top portion of the chamber for dispensing the eye drop solution therethrough, wherein the product label has a temperature indicator formed of a printed thermochromic ink, the temperature indicator adapted to show a distinct color at a proper storage temperature and lose the distinct color at a room temperature.

2. The temperature-indicating eye drop solution container of claim 1, wherein the temperature indicator includes a design of thermometer.

3. The temperature-indicating eye drop solution container of claim 1, wherein the eye drop solution is a solution for the treatment of glaucoma.

4. The temperature-indicating eye drop solution container of claim 1, further comprising a carton for packaging the eye drop solution container, the carton carrying on its outer surface a directions-for-use informing the user of the provision of the temperature indicator.
